(19) United States
(12) Patent Application Publication
(10) Pub. No.: US 2005/0020460 A1
(43) Pub. Date: Jan. 27, 2005

(54) Dispensing systems, dispensers and methods for sustained, incremental release of fragrance

(76) Inventors: Jeffrey I. Goldstein, Cincinnati, OH (US); James F. Keller, Cincinnati, OH (US)

Correspondence Address: HASSE GUTTAG & NESBITT LLC, 7550 CENTRAL PARK BLVD., MASON, OH, 45040, US

(21) Appl. No.: 10/897,043

(22) Filed: Jul. 22, 2004

Related U.S. Application Data
(60) Provisional application No. 60/489,975, filed on Jul. 25, 2003.

(51) Int. Cl. C11D 3/50

(52) U.S. Cl. 510/101

(57) ABSTRACT

A dispensing system for providing a sustained release of fragrance over time by bringing into contact by gravity assistance, mechanical assistance or combination thereof, a discrete, incremental portion of a solid, typically a fragrance-containing solid, and a liquid activator so as to cause sustained, incremental release of the fragrance. The system can additionally a comprise an effervescent component that generates desirable effervescence when the solid is contacted with the liquid activator. Various dispensers and methods that utilize gravity assistance, mechanical assistance or combination thereof can be used to bring the solid and liquid activator into contact to provide this sustained, incremental release of fragrance.

### CROSS REFERENCE TO RELATED APPLICATIONS

This application claims the benefit of copending U.S. Provisional Patent Application Ser. No. 60/489,975, filed Jul. 25, 2003.

### TECHNICAL FIELD

This invention relates to dispensing systems for providing a sustained release of fragrance over time by bringing into contact by gravity assistance, mechanical assistance or combination thereof, a solid and a liquid activator that is capable of causing sustained, incremental release of the fragrance. This invention also relates to various dispensers and methods that utilize gravity assistance, mechanical assistance or combination thereof for bringing these solids and liquid activator into contact to provide a sustained, incremental release of fragrance. This invention further relates to dispensing systems and dispensers for controlling the ability of the solid and liquid activator to release the fragrance in a sustained, incremental manner.

### BACKGROUND OF THE INVENTION

For years, a wide variety of fragrance dispensers have been used to provide general air freshening, fragrance benefits, odor removal or cover-up, or aroma-therapeutic or other benefits including relaxation, invigoration and sinus decongestion. These products include aerosol and non-aerosol disinfectant sprays, sprays containing odor-absorbing chemicals such as cyclodextrin or zeolites, stick-on or pull-up solid gel air fresheners, plug-in electrically heated or warmed fragrances, and scented candles in a wide variety of shapes, sizes, colors and textures. Candles in particular provide the benefits of delivering continuous fragrance release over extended time periods and also provide a visual sensory benefit, namely a lighted flame, that many users find comforting or relaxing.

Each of these products has certain disadvantages. Aerosol dispensers are difficult to manufacture and have potential environmental drawbacks. Aerosol and non-aerosol sprays are also generally perceived to deliver fragrances effectively, but only for a relatively short period of time. Stick-ons, pull-ups and electrical plug-in dispensers lack the visual benefit of burning candles and also may not be perceived to be as natural as candles. However, candles have disadvantages including the potential danger associated with having an open flame that discourages its use, for example, at bedside when trying to sleep, near drapery, in offices where there are rules against having an open flame, around small children or in children's rooms, and the like.

Solids that come in contact with a liquid activator to dispense or release actives other than fragrances are known in the art. For example, U.S. Pat. No. 2,950,959 (Ve Relle), issued Aug. 30, 1960, discloses a dispenser 20 that sequentially loads cylindrical tablets 33 of a deodorizing and purifying chemical that are guided by the walls of the dispenser such that only the bottom tablet is dissolved by water from a urinal, toilet or other device (see, for example, FIGS. 1 and 10 and column 2, lines 17-51). See also U.S. Pat. No. 4,241,025 (Grayson et al), issued Dec. 23, 1980, which discloses a dispenser 1 that has vertically stacked cylindrical chlorinator sticks S1 that are sequentially dissolved by water to be treated until small enough to fall through a gap between protrusions 11a(see FIG. 4a); U.S. Pat. No. 4,110,853 (dela Cruz), issued Sep. 5, 1978, which discloses a dispensing device 10 for toilet bowl tanks that has vertically stacked solids 31 that are dissolved by water entering port 14 (see FIG. 2); and U.S. Pat. No. 2,942,786 (Wenner et al), issued Jun. 28, 1960, which discloses a dispensing device 10 for multiple cylindrical slugs 14 of an air treating gel that sequentially shrink and fall through gel holder 12 (see FIG. 2).

Various devices and methods for distributing fragrances are also known in the art. For example, U.S. Pat. No. 5,574,821 (Babasade), issued Nov. 12, 1996, discloses a volatile substance dispenser that plugs into an electrical outlet to disseminate a vapor into a selected area. See also U.S. Pat. No. 5,230,837 (Babasade), issued Jul. 27, 1993, which discloses a fragrance dispenser wherein a fragrance wheel is saturated with a selected fragrance material, and then rotated with a motor that can be energized by light falling on a photovoltaic cell; U.S. Pat. No.4,145,001 (Weyenberg et al), issued Mar. 20, 1979, which discloses a method for packaging volatile substances, including fragrance materials, within two layers of flexible material, the outer layer being impermeable to volatile vapors, and an inner layer being permeable to such vapors; and U.S. Pat. No. 4,849,606 (Martens et al), issued Jul. 18, 1989, which discloses a tamper resistant container for providing fragrance in an area in which a tray contains the volatile fragrance material, with the top of the tray being secured with a double layer covering, the top layer of which is impermeable to the volatile fragrance material.

One product form that has not been used broadly for the purpose of general air freshening are dissolvable fragrance-containing solids or tablets such as effervescent compositions. Effervescent compositions are well known in the art. These products usually combine a carbonate salt such as sodium carbonate and/or sodium bicarbonate with acidic materials such as citric, malic, or fumaric acid in a way such that carbon dioxide gas is generated by the reaction that occurs when the carbonate and acidic material come into intimate contact with each other in the presence of water (or other aqueous liquid). When these effervescent materials do come into contact with water, this reaction typically occurs very rapidly.

One example of an effervescent fragrance product is disclosed in U.S. Pat. No. 5,993,854 (Needleman et al), issued Nov. 30, 1999, which involves an exothermic effervescent composition for improved fragrance dispersion. The effervescent agent is preferably provided by combining an alkaline carbonate salt or a combination of salts such as sodium carbonate, with an acid such as citric acid, malic acid, fumaric acid, succinic acid or tartaric acid. See col. 2, lines 25-32 of U.S. Pat. No. 5,993,854.

However, it would be desirable to provide an effervescent fragrance system dispensing such solids so as to provide a sustained release of the fragrance that is long-lasting. In addition, it would be desirable to provide a fragrance dispensing system for such solids that produces long-lasting fragrance release without use of an open-flame. It would be also desirable to provide a dispensing system that is capable of delivering fragrance-containing solids to a liquid activator, and vice versa, in such a way as to expose only a portion or fraction of the total solids, or to expose only a small surface area of each solid at a time, to the liquid activator so as to control or slow the rate dissolution of the solids, and thus prolong or sustain the evolution or release of the fragrance, as well as limit the volume of liquid activator (e.g., water) available to slow or retard the desired release of the fragrance or desired effervescent action. It would be further desirable to provide a fragrance dispensing system that is pleasing and enhances the visual and auditory benefits of such products, for example, those produced by fizzing of the effervescent solids. It would yet be further desirable to provide a fragrance dispensing system that optionally allows the user to easily start or stop the release of the fragrance, and potentially increase or reduce the rate of fragrance release.

### BRIEF DESCRIPTION OF THE INVENTION

This invention is broadly directed at dispensing systems, dispensers and methods for providing a sustained release of fragrance over time by bringing incrementally into contact by gravity assistance, mechanical assistance or combination thereof, a liquid activator and an incremental, discrete portion of a solid that, when combined, release a fragrance so as to cause a sustained, incremental release thereof over time.

In an embodiment of this invention, a dispensing system capable of delivering fragrance over extended time periods is provided wherein gravity assistance, mechanical assistance or a combination thereof brings discrete units of fragrance-containing solid into sequential contact with the liquid activator so as to incrementally release the fragrance from these solids.

In another embodiment of this invention, a dispensing system capable of delivering fragrance over extended time periods is provided wherein gravity assistance, mechanical assistance or a combination thereof brings the liquid activator into contact with discrete, sequential units of the fragrance-containing solids so as to incrementally release the fragrance from these solids.

In yet another embodiment of this invention, a dispenser is provided that utilizes gravity assistance, mechanical assistance or combination thereof for bringing the discrete units of fragrance-containing solids into sequential contact with the liquid activator so as to incrementally release the fragrance from these solids.

In yet a further embodiment of this invention, a dispenser is provided that utilizes gravity assistance, mechanical assistance or combination thereof for bringing the liquid activator into contact with discrete, sequential units of the fragrance-containing solids so as to incrementally release the fragrance from these solids.

In yet another embodiment of this invention, the dispensing system (or dispenser) is provided with a mechanism for controlling the liquid activator or reservoir thereof, so that the rate at which the fragrance is released from the fragrance-containing solids is also controlled.

The embodiments of the dispensing system, dispensers and methods of this invention can provide various benefits for the user thereof. These include but are not limited to: (1) providing a sustained release of the fragrance (and preferably effervescent action) that is long-lasting; (2) providing sustained release of the fragrance without use of an open flame; (3) delivering the solids to the liquid activator, and vice versa, in such a way as to control or slow the rate dissolution of the solids, and thus prolong or sustain the evolution or release of the fragrance, as well as limit the volume of liquid activator (e.g., water) available to slow or retard the desired release of the fragrance, as well as any desired effervescent action; (4) providing pleasing and enhanced visual and auditory benefits, for example, due to fizzing or bubbling created by the dissolving and reaction of the effervescent solids; (5) allowing the user to easily start or stop the release of the fragrance, and potentially increase or reduce the rate of fragrance release, as well as any desired effervescent action; (6) providing for longer-lasting, continuous dissolution by allowing progressive rereshing of the liquid activator; (7) providing for enhanced fragrance evaporation by increasing the surface area exposed; (8) providing augmented acoustical and sound benefits from the effervescent action that is generated, for example by using a instrument-shaped component; (9) providing increased aesthetic benefits by using single or multiple-colored solids and/or liquid activator, or by generating single or multiple-colored effects when the solids and liquid activator are combined.

### BRIEF DESCRIPTION OF THE DRAWINGS

FIG. 1 is a view in perspective of an embodiment of the dispensing system of this invention.

FIG. 2 is a view in perspective of alternative embodiment of the dispensing system of FIG. 1.

FIG. 3 is a view in perspective of another embodiment of the dispensing system of this invention.

FIG. 4 is a view in perspective of an alternative embodiment of the dispensing system of FIG. 3.

FIG. 5 is a view in perspective of another embodiment of the dispensing system of this invention.

FIG. 6 is a view in perspective of an alternative embodiment of the dispensing system of FIG. 4.

FIG. 7 is an exploded view in perspective of another embodiment of the dispensing system of this invention.

FIG. 8 is a view in perspective of an alternative embodiment of the dispensing system of FIG. 7.

FIG. 9 is a view in perspective of another embodiment of the dispensing system of this invention.

FIG. 10 is a view in perspective of another embodiment of the dispensing system of this invention.

FIG. 11 is a view in perspective of another embodiment of the dispensing system of this invention.

FIG. 12 is a view in perspective with portions removed of another embodiment of the dispensing system of this invention.

FIG. 13 is a view in perspective with portions in section of another embodiment of the dispensing system of this invention.

FIG. 14 is a view in perspective with portions removed of another embodiment of the dispensing system of this invention.

FIG. 15 is a view in perspective of another embodiment of the dispensing system of this invention.

### DETAILED DESCRIPTION OF THE INVENTION

1. Definitions

As used herein, the terms “solid” and “solids” refer to any composition that is solid at ambient or room temperature that is capable of being dissolved by the liquid activator.

As used herein, the term “fragrance-containing solid” refers to any solid that contains releasable fragrance therein.

As used herein, the term “liquid activator” refers to any composition that is liquid at ambient or room temperature that is capable of dissolving the solid when combined therewith, and is also capable of generating the fragrance when combined with the solids, for example, by releasing the fragrance from the fragrance-containing solid when brought into contact therewith, in generating an effervescent action when combined with the solids, and/or generating single or multiple-color effects when combined with the solids.

As used herein, the term “comprising” means various compositions, compounds, components, layers, steps and the like can be conjointly employed in this invention. Accordingly, the term “comprising” encompasses the more restrictive terms “consisting essentially of” and “consisting of.”

All amounts, parts, ratios and percentages used herein are by weight unless otherwise specified.

2. Solids and Liquid Activators

A variety of compatible solids and liquid activators can be used in this invention. The fragrance that is released by contact between the solids and the liquid activator can be present in the solids, the liquid activator or both. Typically, the fragrance is present in the solids, i.e., “fragrance-containing solids,” the fragrance being released when the solids are brought into contact with the liquid activator. Typically, the liquid activator is an aqueous solution, more typically water. When water is used as the liquid activator, the solids are at least partially soluble or dissolvable in water.

An effervescent component is also typically included as part of the solids, the liquid activator or both to provide a desirable visual and auditory effect when the solids and liquid activator are brought into contact. Such effervescent components typically rely on the generation of carbon dioxide by bringing into contact at least one alkaline carbonate or bicarbonate salt with at least one a suitable acid in the presence of the liquid activator, e.g., water. For example, the alkaline carbonate salt(s) can be included as at least a portion of the solids, while the acid(s) is included as at least a portion of the liquid activator, e.g., an aqueous acid solution. Typically the alkaline carbonate salt(s) and the acid(s) are included as at least a portion of the solids.

Suitable alkaline carbonate salts for use herein include, but not limited to, sodium bicarbonate, sodium carbonate, sodium sesquicarbonate, potassium bicarbonate, potassium carbonate, potassium sesquicarbonate, magnesium carbonate, ammonium bicarbonate, ammonium carbonate, ammonium sesquicarbonate, and calcium carbonate.

Suitable acids for use herein include, but are not limited to, formic acid, acetic acid, propanoic acid, butyric acid, valeric acid, oxalic acid, malonic acid, tartaric acid, succinic acid, glutaric acid, adipic acid, glycolic acid, aspartic acid, pimelic acid, fumaric acid, maleic acid, phthalic acid, isophthalic acid, terephthalic acid, glutamic acid, lactic acid, hydroxyacrylic acid, alpha-hydroxybutyric acid, glyceric acid, tartronic acid, hydroxybenzoic acid, citric acid, salicylic acid, gallic acid, mandelic acid, tropic acid, ascorbic acid, gluconic acid, cinnamic acid, benzoic acid, phenylacetic acid, nicotinic acid, kainic acid, sorbic acid, pyrrolidonecarboxylic acid, trimellitic acid, benzenesulfonic acid, toluene sulfonic acid, potassium dihydrogen phosphate, sodium sulfite, sodium dihydrogen phosphate, potassium sulfite, sodium pyrosulfite, acidic sodium hexametaphosphate, acidic potassium hexametaphosphate, acidic sodium pyrophosphate, acidic potassium pyrophosphate, sulfamic acid and phosphoric acid. The exact combination of acidic and alkaline carbonate salts can be varied in order to give an acidic or alkaline pH. They can also be varied to enhance the stability and physical properties of the fragrance-containing solids.

A variety of fragrances can also be used with the solids and/or liquids, including one or more volatile materials or perfumes that are able to emanate aroma or fragrance. Examples of such perfumes include, but are not limited, natural perfumes which originate from natural plants and animals and whose aromatic ingredients are collected therefrom by physical and chemical treatments such as steam distillation, extraction and the like, chemical substances derived from resources such as coal, petroleum, natural gas, oils and fats, and perfumes prepared through chemical reactions of the natural perfumes and isolated perfumes, such as by oxidation, reduction, condensation, hydrolysis, substitution, addition and transition. Specific examples of such perfumes include animal perfumes such as musk oil, civet, castreum, ambergris, plant perfumes such as sandalwood oil, neroli oil, bergamot oil, lemon oil, lavender oil, sage oil, rosemary oil, peppermint oil, eucalyptus oil, menthol, camphor, verbena oil, citronella oil, cauout oil, salvia oil, clove oil, chamomille oil, sandalwood oil, costus oil, labdanum oil, broom extract, carrot seed extract, jasmine extract, mimosa extract, narcissus extract, olibanum extract, rose extract and the like, and chemical substances such as acetophenone, dimethylinadane derivatives, naphthaline derivatives, allyl caprate, alpha-amylcinnamic aldehyde, anethole, anisaldehyde, benzyl acetate, benzyl alcohol, benzyl propionate, borneol, cinnamyl acetate, cinnamyl alcohol, citral citronnellal, cumin aldehyde, cyclamen aldehyde, decanol, ethyl butyrate, ethyl caprate, ethyl cinnamate, ethyl vanillin, eugenol, geraniol, hexenol, alpha-hexylcinnamic aldehyde, hydroxycitrolnellal, indole, iso-amyl acetate, iso-amyl acetate, iso-amyl iso-valerate iso-eugenol, linalol, linalyl acetate, p-methylacetophenone, methyl anthranilate, methyl dihydroasmonate, methyl eugenol, methyl-beta-naphthol ketone, methylphenylcarbinyl acetate, musk ketol, musk xylol, 2,5,6-nanodinol, gamma-nanolactone, phenylacetoaldehydodimethyl acetate, beta-phenylethyl alcohol, 3,3,5-trimethylcyclohexanol, gamma-undecalactone, undecenal, vanillin and mixtures thereof.

Suitable fragrance-containing solids for use in this invention that also include the effervescent component are disclosed in, for example, U.S. Pat. No. 5,993,854 (Needleman et al), issued Nov. 30, 1999, which is incorporated by reference. As disclosed in Needleman et al, one or more exothermic agents can also be included in the fragrance-containing solids if desired. The exothermic agent is chosen from those compounds that have positive heats of solution so that a temperature rise is achieved when the product is placed in water. Some exemplary materials are magnesium chloride, magnesium sulfate, ferric chloride, aluminum sulfate hexahydrate, and aluminum chloride. In general the exothermic material chosen should preferably have an exothermic heat of solution greater than about 10 kcal/gram-mole. Materials with exothermic heats of solution suitable for use herein include, but are not limited to, aluminum bromide, aluminum chloride, aluminum iodide, aluminum sulfate hexahydrate, antimony pentachloride, barium hydroxide, barium iodide, barium oxide, barium oxide monohydrate, beryllium chloride, cadmium sulfate, calcium bromide, calcium chloride, calcium iodide, calcium oxide, cessium hydroxide, cessium oxide, chromium bromide hexahydrate, chromium chloride, hydrobromic acid, hydrochloric acid, hydroiodic acid, ferrous chloride, ferric chloride, lithium bromide, lithium iodide, lithium oxide, magnesium bromide, magnesium chloride, magnesium sulfate, magnesium iodide, manganese chloride, manganese sulfate, neodymium chloride, nickel nitrate, phosphorous trichloride, platinum chloride, potassium oxide, potassium sulfide, rubidium oxide, sodium tetraborate, sodium phosphate, sodium selenide, sodium sulfide, strontium bromide, stannic chloride, zinc chloride, zinc bromide, zinc sulfate, and zinc iodide.

The fragrance-containing solids can further comprise other ingredients, in amounts not impeding the effect of the aromatic composition. Such other ingredients include, for example, saccharides, surface active agents (i.e., surfactants), binders, buffers, oils and fats, high molecular weight compounds, and the like.

The fragrance-containing solids can be of any suitable shape and configuration, including spherical (i.e., like a ball), cylindrical, oval-, elliptical-, or egg-shaped, disc-shaped, box- or cube-shaped, etc.,and can be provided with bores, holes or other apertures to allow the solids to be suitably loaded for dispensing.

If desired for additional visual and aesthetic effects, the fragrance-containing solids and/or liquid activator can be of single color or can be of multiple colors, and can also be formulated to generate single or multiple colors when combined.

2. Dispensing Systems

A variety of dispensing systems can be used to incrementally bring the solids and liquid activator into contact to provide an incremental sustained release of the fragrance. These dispensing systems typically comprise a dispenser or container for the solids and a reservoir for containing the liquid activator. The solids and liquid can be brought into incremental contact in any suitable manner that uses gravity assistance, mechanical assistance or a combination thereof. Some non-limiting examples included: (1) using gravity to dispense the fragrance-containing solids to the liquid activator; (2) using gravity to feed the liquid activator to the fragrance-containing solids; (3) using mechanical devices or components (e.g., by spring or other biasing mechanism, paddle wheel, electrical motor, etc.) to dispense the fragrance-containing solids, liquid activator or both; and (4) using gas generated by release of the fragrance, or by the reaction of the effervescent component, to assist in dispensing the fragrance from the fragrance-containing solids and or the liquid activator.

Suitable dispensers or containers for the fragrance containing solids include, but are not limited to: (1) inclined surfaces such as tracks or ramps that can be linear, spiral, helical, other configurations or combinations of such configurations; (2) generally vertical guides such as hollow cylindrical chambers, or a post or pole for loading the fragrance containing solids that have a bore or hole therein to allow for loading on the post/pole; and (3) containers having inclined walls provided with an opening or outlet at the bottom thereof such as a funnel. The liquid activator can simply be passively contained within the reservoir or, when actively brought into contact with the solids, can be dispensed from similar dispensers as the solids or from dispensers configured for the dispensing of liquids.

In operation, the dispenser utilizes gravity, mechanical assistance or both to sequentially dispense a portion of the fragrance-containing solids and/or a portion of the liquid activator) so that the solids and liquid activator are brought into contact with each other. For example, when downward-sloping or vertical guides such as a ramp, tube, funnel or other externally guided mechanisms are used as dispenser, the first portion of the solid (e.g., a discrete unit such as a sphere) is at least partially submerged so as to come in contact with the liquid activator, with remaining the portion being positioned or arrayed behind or above the first portion of solids. When the liquid activator dissolves the first portion of solids, its fragrance is released, and as the dissolution process continues to dissolve the first portion of solids, subsequent portions or portion of the solid advance down or along the guide due to gravity or mechanical assistance, and then come in contact with the liquid itself. The process continues until the last portion of solid is dissolved or the liquid activator approaches the solubility and/or pH limit of the dissolved solids therein such that fragrance release and effervescent action (if an effervescent component is present) occurs very slowly or not at all.

The dispensing system of this invention can include a stop, wall or other barrier to restrain or arrest the movement of the solids so that only the first portion of the solids is immersed in the liquid activator. The liquid activator can also be continuously or incrementally channeled, dripped, pumped, flowed, sprayed or sprinkled onto the first portion of the solids.

One or more optional features can also be used in order to encourage longer release of the fragrance, or to provide other additional benefits. One such feature is a mechanism that allows only a portion of the solid's surface area to be exposed to the liquid activator, thereby slowing the rate of dissolution. Another embodiment of this mechanism includes a shallow liquid reservoir that is less than the height of the solid. Another embodiment includes a reservoir that is deeper than the height or width of the solid but has one or more openings in the wall of the reservoir, or a shorter area or section in one wall of the reservoir that is below the top of the solid, i.e., the solid is only partially immersed in the liquid activator.

Another optional feature of this invention is to control the rate of dissolution by controlling the volume of liquid and its level of saturation of the solids, including any effervescent components, e.g., carbonate salts and/or acids. This can be accomplished by providing the reservoir with a first section of a fixed size combined, with an additional section (or sections) beyond the overflow area of the first section to accept the flow of excess liquid. As the level of saturation increases and the dissolution rate slows in the first section, more liquid activator can be added in order to dilute that already present in the reservoir, and thus accelerate the dissolution rate, the excess liquid activator meanwhile flowing into the overflow area. The dispensing system can also be provided with a mechanism for the user to easily refill the reservoir with fresh liquid activator manually or via an automated fresh liquid input mechanism, or to cause saturated liquid to depart or be removed from the reservoir, with additional fresh liquid activator being drawn in to replace the saturated liquid. These can include dividing the reservoir into different sections that are in liquid communication with each other where the first or primary section contains the liquid activator in contact with the solids, and wherein the second or secondary section allows the excess or saturated liquid activator, or some portion thereof, to flow away from the primary section, to provide fresh activator fluid to the primary section, or a combination thereof. The reservoir can also be provided with an outlet or valve for controlling the volume/amount and level of liquid activator therein.

Yet another optional feature of this invention is to provide a mechanism that halts the contact between the solids into the liquid, thereby arresting dissolution of the solids and fragrance release until later desired. A further optional feature is the incorporation of an evaporating pad or slide which channels excess liquid out of the first or second section that is intended to provide additional surface area for evaporation to further enhance fragrance distribution. The distribution of fragrance can also be enhanced by allowing the combined liquid activator and solids to drip, sprinkle or flow in a suitable manner like a waterfall through the air. An additional optional feature is the use of an auditory component, for example configured in the shape of a bell of a musical instrument, to enhance the auditory benefit of the fizzing and bubbling of the effervescence when an effervescent component is used. A further aesthetically pleasing alternative feature is to use the gas pressure generated by the effervescent reaction to spin a pinwheel or similar device.

Optional embodiments of this invention can also seek to provide enhanced aesthetic benefit by including scented candles that are integrated in the dispensing system in a suitable manner (e.g., as a component of the dispenser design) so as to provide an additional fragrance benefit beyond that achieved by the release of fragrance when the solids and liquid activator are brought into contact. Some of these embodiments can be provided with a liquid-filled moat surrounding the candle, i.e., to extinguish the flame if the candle tipped over to increase the safety of using the candle.

With regard to the various embodiments of this invention, several features thereof can be used to regulate the rate and duration of fragrance release when dissolving the effervescent fragrance-containing solids, including but not limited to the size and hardness of the fragrance-containing solids, the portion of the surface area of the solid which is exposed to the liquid, the volume of liquid relative to the volume of solid dissolved, and the temperature of the liquid and various aspects of the composition such as the solubility of the carbonate salt chosen, the acidity and solubility of the acid used, whether and to what extent a coating agent such as polyethylene glycol is used to enhance stability and slow dissolution, etc. For example, if the effervescent solid produces an endothermic reaction when dissolved, the rate of dissolution of the effervescent solid can be decreased as the temperature of the liquid decreases. In addition, as the effervescent components dissolve, the level of unreacted carbonate salts and acids in the liquid can increase, thus decreasing the rate of dissolution of these components and thus making them less available to react and generate the desired effervescent action; the rate of dissolution can also be controlled by increases and decreases in the pH of the liquid.

The various embodiments of this invention can also be provided as a product or kit with a set of instructions for use of the system, dispenser, and other components of the product or kit. For example, these instructions can be written or printed on the packaging or labelling that the product or kit is sold or distributed in or with, or on a sheet(s) of paper separately therefrom. Alternatively, the product or kit can include computer software (e.g., in the form of a floppy disk(s), CD ROM disk(s) or other non-volatile electronic storage media) packaged or otherwise associated with the product or kit that provides the instructions on how to use the system, dispenser, and other components of the product or kit, or the instructions can be provided and obtained electronically (e.g., via the Internet) from a remote site, such as from a web site or computer server that are written or printed on sheet of paper or on the packaging or labelling of product or kit of this invention.

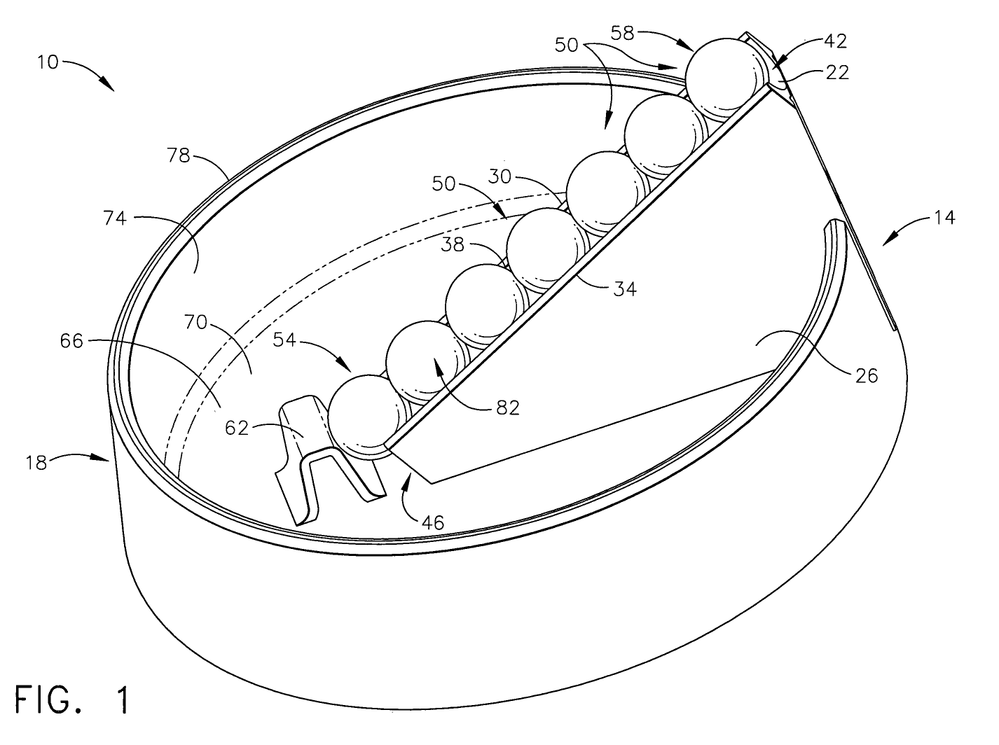

The various embodiments of this invention are further illustrated by reference to the drawings as described hereafter. Referring to the drawings, FIG. 1 shows an embodiment of the fragrance dispensing system indicated generally as 10. System 10 includes a dispenser generally indicated as 14 in the form of an inclined ramp, and a generally bowl-shaped liquid activator reservoir 18 in which ramp 14 is positioned. Ramp 14 includes an inclined surface 22 having a semicircular shape along its length or longitudinal axis that is supported by a pair of spaced apart walls 26 and 30 that extend upwardly from reservoir 18 and have respective inclined upper edges 34 and 38 that intersect with and connect to surface 22. Walls 26 and 30 can be releasably or permanently attached to reservoir 18 or can be formed integrally therewith. Edges 34 and 38 and surface 22 define a guide channel having an upper entrance 42 at the top thereof and a lower exit 46 at the bottom thereof.

As shown in FIG. 1, a plurality of generally spherical fragrance-containing solids 50 are sequentially loaded onto inclined surface 22. As also shown in FIG. 1, these solids are sized so as to be able to move downwardly along inclined surface 22 due to gravity. The first or lower most solid indicated as 54 is shown as being proximate exit 46, while the last or upper most solid indicated as 58 is shown as being proximate entrance 42. Solid 54 is held in place against further movement down inclined surface 22 by a hump-shaped stop indicated as 62 that is releasably or permanently attached to or integral with reservoir 18. Reservoir 18 has an inner surface indicated generally as 66 that has a base or bottom indicated as 70, and a wall 74 that extends vertically and upwardly from base 70 and terminates at upper edge 78.

In operation, inclined surface 22 of ramp 14 is filled or loaded with solids 50 and then reservoir 18 is filled with the liquid activator, such as water, or vice versa, such that first solid 54 is at least partially immersed in the water. The first solid 54 which rests against stop 62 comes into contact with the water in reservoir 18, thus releasing the fragrance contained therein as solid 54 is dissolved. If solid 54 also contains a water-activated effervescent component, contact with the water in reservoir 18 will also cause desirable effervescence to occur as well. Over time, solid 54 is progressively dissolved by the water in reservoir 18 and eventually decreases in size and loses its integrity. As solid 54 decreases in size/loses integrity, the next adjacent solid 82 advances down inclined surface 22 due to gravity, and eventually comes into contact with the water in reservoir 18 when solid 54 has partially or completely dissolved, thus continuing the process of incremental fragrance release, as well as desirable effervescence generation. Like solid 54, the movement of solid 82 down inclined surface 22 is arrested by stop 62. This process continues until the last solid 58 has been completely or almost completely dissolved, or until the water in reservoir 18 approaches the solubility or pH limit of the dissolved solids 50 in the liquid activator such that fragrance release and effervescent action occurs very slowly or not at all.

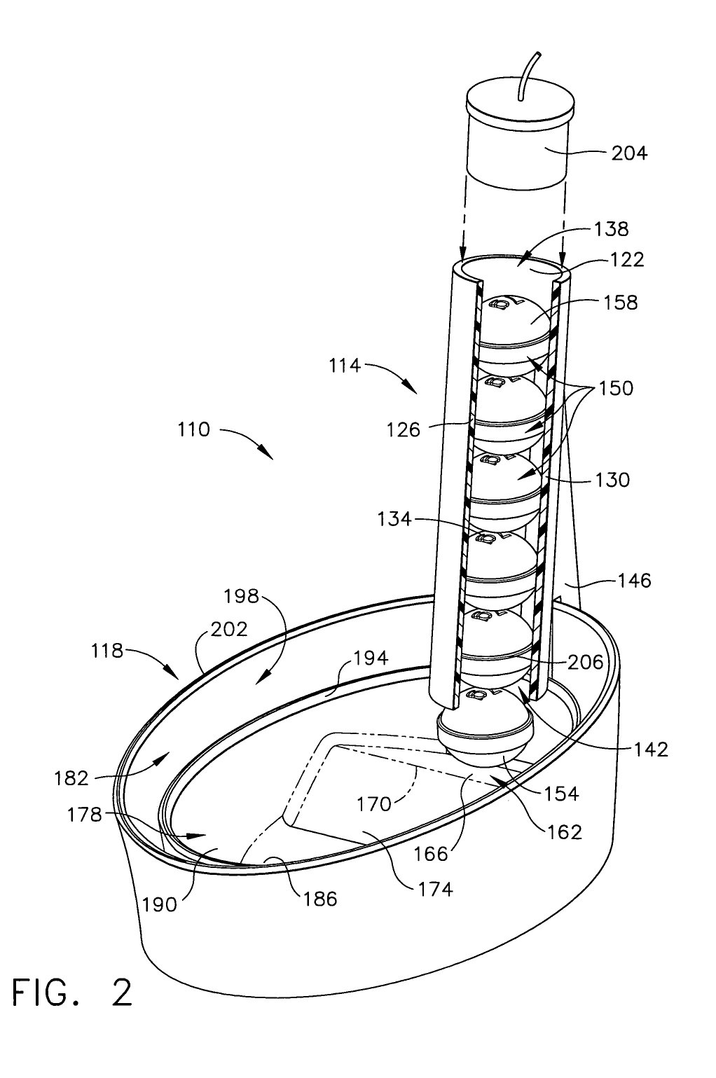

FIG. 2 shows an alternative embodiment of this dispensing system indicated generally as 110. System 110 has a dispenser in the form of a generally cylindrical shaped vertical guide chamber indicated as 114, and a bowl-shaped liquid activator reservoir indicated generally as 118. Chamber 114 has an inner generally cylindrical surface 122 that terminates in a pair of spaced apart vertically extending edges 126 and 130. Edges 126 and 130 define a vertically extending opening or gap indicated as 134 that extends from the upper or top entrance 138 downwardly to the lower or bottom exit 142 of chamber 114. Chamber 114 is also provided with a support indicated as 146 for releasably or permanently securing it with or to system 110 so that exit 142 is positioned over reservoir 118.

As shown in FIG. 2., a plurality of generally spherical fragrance containing solids 150 are vertically and sequentially loaded within chamber 114. As also shown in FIG. 2, these solids 150 are sized to be smaller than inner surface 122, but larger than vertically extending gap 134 so that these solids can be sequentially dispensed within chamber 114 due to gravity. The first or lower most solid indicated as 154 is shown as being proximate exit 142, while the last or upper most solid indicated as 158 is proximate entrance 138. Solid 154 is held in place proximate exit 142 by stop 162 that is releasably or permanently attached to or integral with reservoir 118, and has a rearward surface 166 that slopes downwardly and rearwardly from peak 170, and a forward surface 174 that slopes downwardly and forwardly from peak 170.

As shown in FIG. 2, reservoir 118 has an inner section indicated generally as 178, and an outer section indicated generally as 182. Reservoir 118 has a base or bottom 186 from which inner wall 190 of section 178 extends vertically upwardly and terminates at upper edge 194. Outer section 182 has outer wall 198 that extends vertically upwardly from bottom 186, and terminates at upper edge 202. As shown in FIG. 2, edge 202 of outer wall 198 is vertically above edge 194 of inner wall 190, i.e., outer wall 198 is higher than that of inner wall 190. For aesthetic and functional benefits, dispensing system 110 can also be provided with a candle indicated as 204 that fits within entrance 138 of chamber 114 after it is filled with solids 150.

In operation, chamber 114 is filled or loaded with spherical solids 150 and then inner section 178 of reservoir 118 only is typically filled with the liquid activator, such as water, or vice versa. The first solid 154 rests against rearward surface 166 of stop 162 and comes into contact with the water in inner section 178, thus releasing the fragrance contained therein as solid 154 is dissolved, and also creating an effervescent action if solid 154 also contains a water-activated effervescent component. Over time, solid 154 is progressively dissolved by the water in inner section 178, and eventually decreases in size and loses its integrity. As solid 154 decreases in size/loses integrity, the next adjacent solid 206 advances downwardly within chamber 114 due to gravity, and eventually comes into contact with the water in section 178 when solid 154 has partially or completely dissolved, thus continuing the process of fragrance release, as well as desirable effervescence. Like solid 154, the downward progress of solid 206 within chamber 114 is arrested by surface 166 of stop 162. This process continues until the last solid 158 has been completely or almost completely dissolved, or until the water in section 178 approaches the solubility or pH limit of the dissolved solids 150 in the liquid activator such that fragrance release and effervescent action occurs very slowly or not at all. Additional liquid activator can also be added to section 178, thus diluting the concentration of the mixture of dissolved solids 150 and the liquid activator therein, in which case the effervescent action and fragrance release will resume or accelerate, with any liquid activator that exceeds the capacity of section 178 in volume overflowing above edge 194 and spilling into outer section 182 to be retained therein.

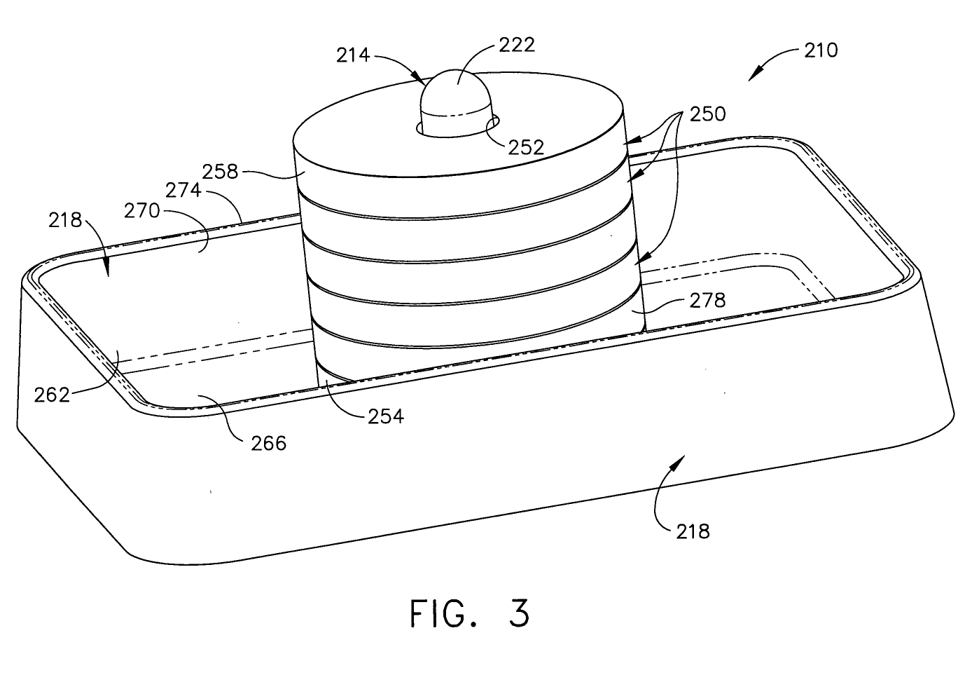

Another embodiment of this dispensing system is shown in FIG. 3 and is indicated generally as 210. System 210 includes a dispenser in the form an elongated generally cylindrical vertical post 214 and a tray-shaped liquid activator reservoir generally indicated as 218. Post 214 can be releasably or permanently attached to or integral with reservoir 218 and extends vertically upwardly therefrom and terminates at upper end 222, and. As also shown in FIG. 3, a plurality of fragrance containing solids in the form of generally circular shaped disks 250 are provided that each have an aperture or hole indicated as 252 having a diameter sized larger than the diameter of post 214 so that disks 250 can be sequentially loaded thereon. The first or lower most disk indicated as 254 is at the bottom of post 214, while the last or upper most disk indicated as 258 is proximate upper end 222 of post 214. Reservoir 218 has an inner surface indicated generally as 262 that has a base or bottom indicated as 266 and a wall 270 that extends vertically and upwardly from bottom 266 and terminates at upper edge 274.

In operation, disks 250 are loaded onto post 214 and then reservoir 218 is filled with the liquid activator, such as water, or vice versa. The first disk 254 which rests on bottom 266 comes into contact with the water in reservoir 218, thus releasing the fragrance contained therein as disk 254 is dissolved, and also creating an effervescent action if disk 254 also contains a water-activated effervescent component. Over time, disk 254 is progressively dissolved by the water in reservoir 218, and eventually decreases in size and loses its integrity. As disk 254 decreases in size/loses integrity, the next adjacent disk 278 advances downwardly along post 214 due to gravity, and eventually comes into contact with the water in reservoir 218 when disk 254 has partially or completely dissolved, thus continuing the process of fragrance release, as well as desirable effervescence. This process continues until the last disk 258 has been completely or almost completely dissolved, or until the water in reservoir 218 approaches the solubility or pH limit of the dissolved disks 250 in the liquid activator such that fragrance release and effervescent action occurs very slowly or not at all.

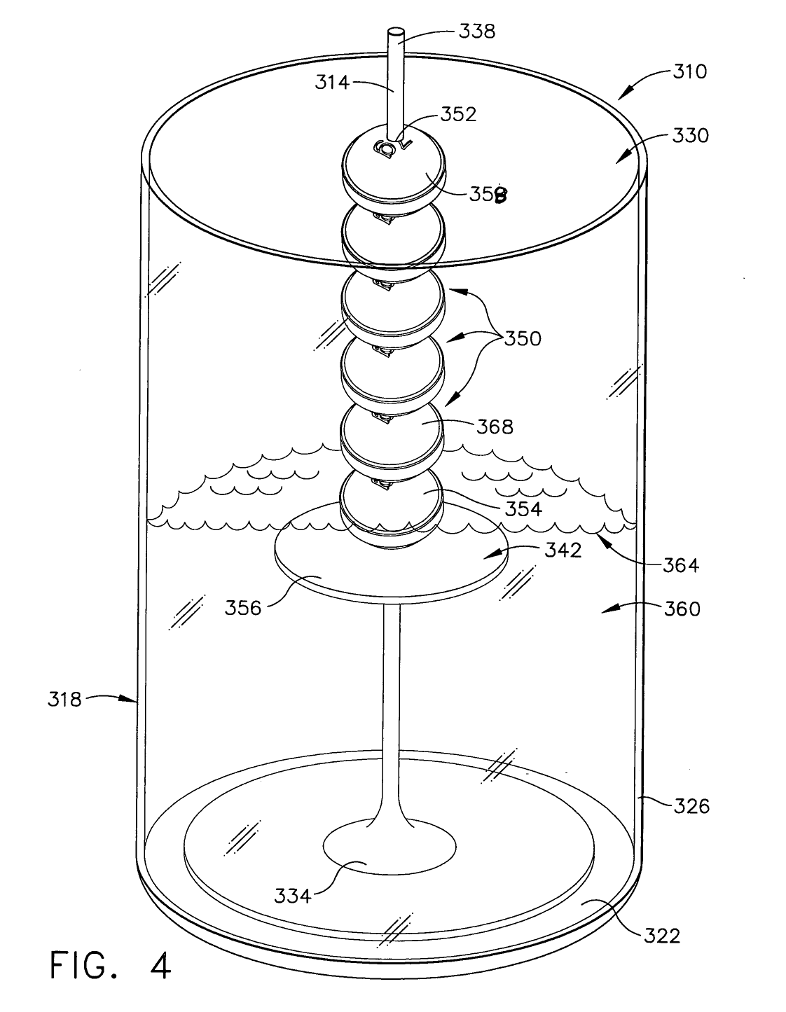

An alternative embodiment of the dispensing system of FIG. 3 is shown in FIG. 4 and is indicated generally as 310. System 310 includes a dispenser in the form of an elongated vertical pole 314, and a generally cylindrical transparent housing indicated as 318 having a base or bottom 322, a generally cylindrical wall 326 extending upward from base 322 and terminating in a generally circular opening indicated as 330 at the top thereof. Pole 314 is attached to or integral with base 322 at the lower portion or end thereof as indicated by 334, extends vertically upwardly from or proximate the center of base 322, and terminates at the lower portion or end 338 that that is shown in FIG. 4 as extending beyond opening 330. A horizontal generally circular platform indicated 342 is secured pole 314, and is positioned between lower end 334 and upper end 338, typically in or proximate the middle section of pole 314.

As shown in FIG. 4, a plurality of generally spherical fragrance-containing solids 350 are provided, each solid having generally cylindrical bore indicated as 352 through the center thereof that is sized larger than the diameter of pole 314 so that solids 350 can be vertically and sequentially loaded onto pole 314. The first or lower most solid indicated as 354 rests on the top surface 356 of platform 342, while the last or upper most solid indicated as 358 is proximate end 338 of pole 314. As shown in FIG. 4, housing 318 has a lower reservoir indicated as 360 that is filled with a liquid activator such as water to a level indicated by 364 such that lower most solid 354 is at least partially immersed in the water.

In operation, the lower most solid 354, being at least partially in contact with the water in reservoir 360, begins to dissolve, thus releasing the fragrance contained therein, and also creating an effervescent action if solid 354 also contains a water-activated effervescent component. Over time, solid 354 is progressively dissolved by the water in reservoir 360, and eventually decreases in size and loses its integrity. As solid 354 decreases in size/loses integrity, the next adjacent solid 368 falls or advances along pole 314 due to gravity, and eventually becomes partially immersed in the water in reservoir 360 as it falls below level 364, thus continuing the process of fragrance release, as well as desirable effervescence. Like solid 354, the downward progress of solid 368 along pole 314 is arrested by the surface 356 of platform 342. This process continues until the last solid 358 has been completely or almost completely dissolved, or until the water in reservoir 360 has reached the solubility limit or pH limit of the dissolved solids 350 in the liquid activator such that fragrance release and effervescent action occurs very slowly or not at all.

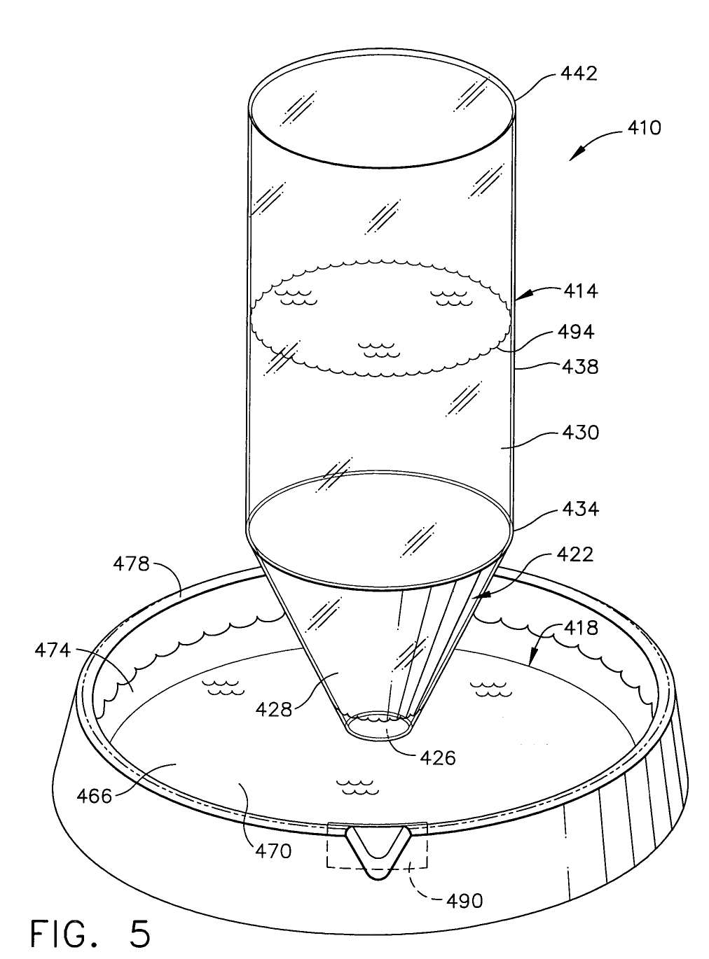

Another embodiment of this dispensing system is shown in FIG. 5 and is indicated generally as 410. System 410 includes a generally silo-shaped transparent housing indicated as 414 and a generally circular bowled-shaped reservoir 418. Housing 414 has a generally frustoconically-shaped or funnel-like lower section indicated as 422 having a lower circular opening or outlet indicated as 426 and a wall 428 extending upwardly to connect with a generally cylindrically shaped upper section 430 connected at a common edge 434. Upper section 430 has a wall indicated as 438 -extending vertically upwardly from edge 434 and terminating in generally circular ceiling indicated as 442 at the top thereof.

Reservoir 418 has an inner surface indicated as 466 that has a base or bottom indicated as 470, and a generally cylindrical wall 474 that extends vertically and upwardly from bottom 470 and terminates at upper edge 478. As shown in FIG. 5, wall 474 is provided with a valve indicated generally as 490 for adjusting the level of liquid activator indicated as 494 within housing 414.

In operation, the embodiment in FIG. 5 provides for an intermittent or continuous addition of liquid activator to reservoir 418 to be used in combination with various dispensers of fragrance-containing solids, including those shown in the various FIGs. previously and hereafter. Housing 414 is filled with liquid activator and then inverted into a downward direction into reservoir 418. In doing so, some of the liquid activator is released to allow the level of the liquid to be released and graduate below or up to level 494. Since there is no opening in housing 414 other than that which is submerged in liquid activator, the combination of the vacuum formed inside housing 414 and the water pressure and surface tension of the existing liquid activator in reservoir 418 prevents the remaining liquid in housing 414 from flowing uncontrollably outwardly. This can be used to reduce the slowdown or ceasing of incremental fragrance release from fragrance-containing solids caused by reaching the solubility or pH limit in one of two ways, either by using a valve 490 which is periodically manually (or mechanically) operated to release a flow of liquid activator from reservoir 418, or by valve 490 providing a slow continuous drip out of liquid activator from reservoir 418. This can cause fresh, unsaturated liquid activator in housing 414 to be continuously released and dispensed into the reservoir 418, thereby diluting the concentration of the mixture of dissolved solids in the liquid activator, in which case the effervescent action and fragrance release can resume or accelerate, with any liquid activator exceeding the capacity of reservoir 418 in volume overflowing through valve 490 and spilling into an outer section (not shown) to be retained therein.

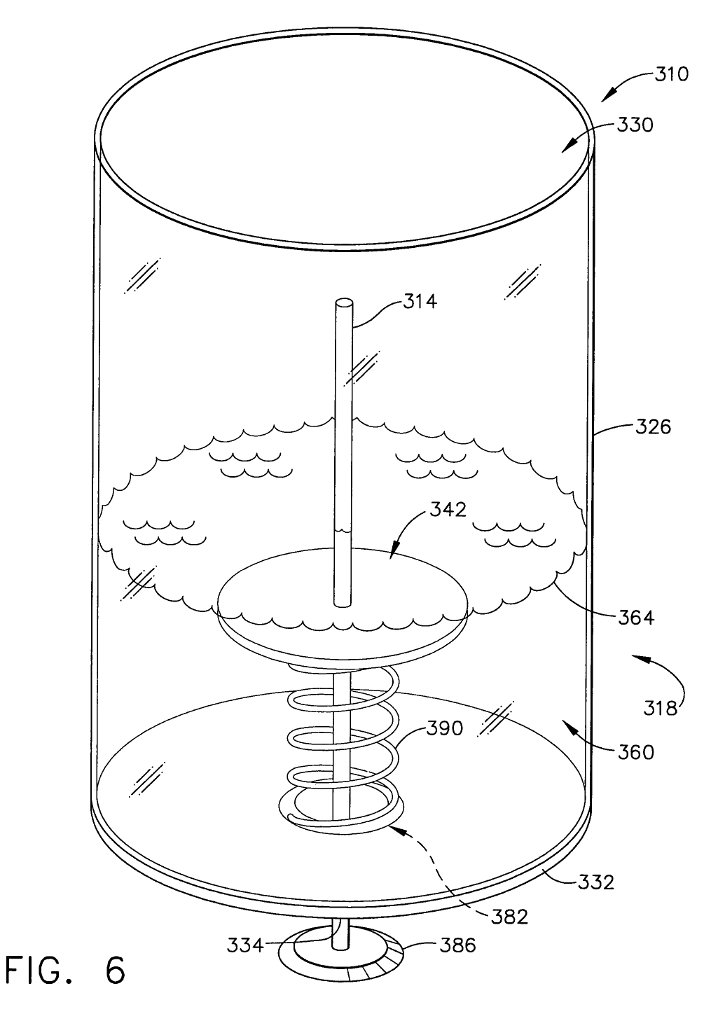

An alternative embodiment of the dispensing system of FIG. 4 is shown in FIG. 6 with regard to controlling the level 364 of liquid activator such as water. As shown in FIG. 6, bottom 322 of housing 318 is provided proximate the center thereof with a generally circular opening or outlet indicated as 382. To prevent water from running out of outlet 382, pole 314 is provided at lower end 334 with a generally circular closure indicated as 386 that is sized to fit over outlet 382. Closure 386 is urged into a closed configuration by a suitable biasing mechanism such as spring 390. If it is desired to lower the level 364 of the water in reservoir 360, pole 314 can be urged downwardly to move closure 386 downwardly, thus uncovering outlet 382 and allowing water in reservoir 360 to flow out.

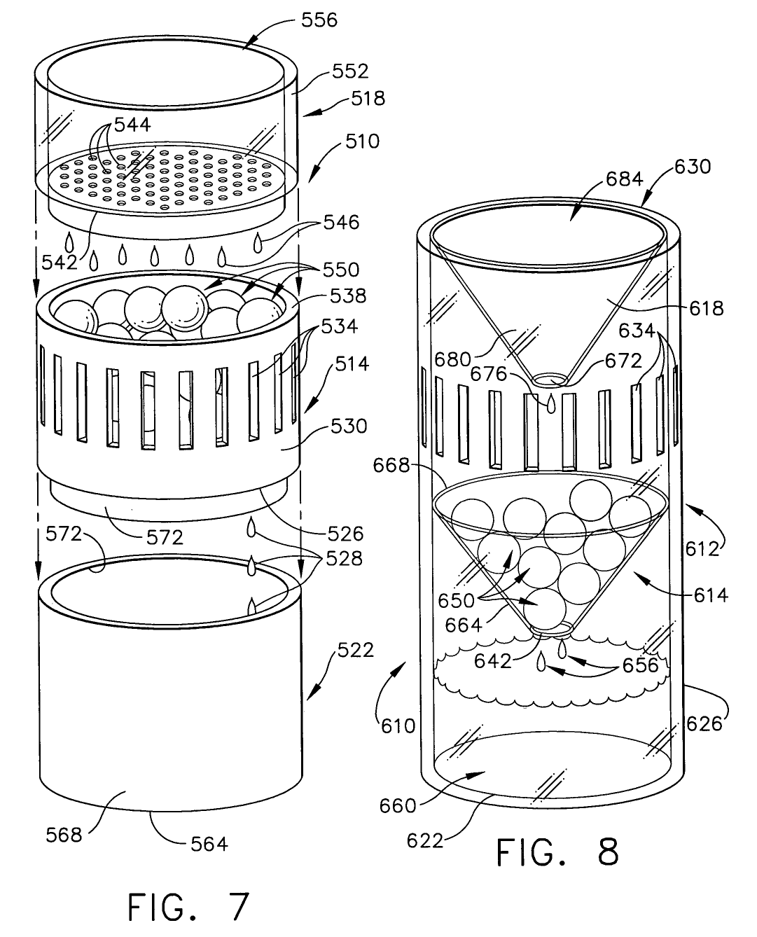

Another embodiment of this dispensing system is shown in FIG. 7 and is indicated generally as 510. System 510 comprises an intermediate chamber in the form of a generally cylindrical fragrance solids container 514, an upper chamber in the form of a generally cylindrical liquid activator reservoir 518, and a lower chamber in the form of a generally cylindrical liquid collection cup 522. Container 514 has a generally circular base or bottom 526 that is provided with holes or apertures (not shown) to allow the escape of liquid into cup 522 as indicated by drops 528, a generally cylindrical wall 530 that extends upwardly from base 526, is provided with a plurality of vents in the form of rectangular apertures 534 spaced along the circumference thereof, and terminates at a generally circular upper edge indicated as 538.

Reservoir 518 has a generally circular base or bottom 542 that is provided with a plurality of holes or apertures indicated as 544 to allow the liquid activator in reservoir 518 to flow into container 514 as indicated by drops 546 that fall onto the plurality of generally spherical fragrance-containing solids 550 held with container 514. Reservoir 518 is also provided with a generally cylindrical wall 552 that extends upwardly from base 542 and terminates in a generally circular opening indicated as 556 at the top thereof. Base 542 of reservoir 518 is sized and configured to fit securely within opening 538 of container 514.

Cup 522 has a has a generally circular base or bottom 564 and a generally cylindrical wall 568 that extends upwardly from base 564 and terminates in a generally circular opening indicated as 572 at the top thereof. Base 526 of container 514 is sized and configured to fit within opening 572 of cup 522.

In operation, intermediate chamber 514 is filled or loaded with solids 550 and then upper chamber 518 is filled with the liquid activator, such as water, or vice versa. The liquid activator drips through holes 542 onto one or more solids 550, thus releasing the fragrance contained therein as solids 550 are dissolved, the fragrance then passing outwardly through vents 534. If solids 550 also contain a water-activated effervescent component, contact with the water in intermediate chamber 514 will cause desirable effervescence to occur as well. Over time, one or more of solids 550 will become progressively dissolved by the liquid activator descending from holes 544, and eventually decreases in size and loses its integrity, thus causing other adjacent solids to shift and advance into their place due to gravity, thus continuing the process of incremental fragrance release, as well as desirable effervescence generation. At the same time, the liquid activator that descends into intermediate chamber 514 is drained off via holes (not shown) in base 526, as indicated by drops 528, into cup 522. This process continues until the last solid 550 has been completely or almost completely dissolved, or until the liquid activator in upper chamber 518 is completely dispensed into intermediate chamber 514 and finally into cup 522.

An alternative embodiment of the dispensing system of FIG. 7 is shown in FIG. 8 and is indicated as 610. System 610 comprises a generally cylindrical transparent housing indicated as 612, a lower generally frustoconically-shaped or funnel-like solids container indicated as 614, and an upper generally frustoconically-shaped or funnel-like liquid activator reservoir indicated as 618 spaced vertically from container 614. Housing 612 has a generally circular base or bottom indicated as 622, a generally cylindrical wall indicated as 626 that extends upwardly from base 622, and terminates at a generally circular upper edge indicated as 630. As shown in FIG. 8, wall 626 is provided with a plurality of vents in the form of rectangular apertures 634 spaced along the circumference thereof.

Solids container 614 has a generally circular lower opening or outlet 642 that is sized smaller than the diameter of each of a plurality of generally spherical fragrance-containing solids indicated as 650, but is large enough to permit liquid to escape as indicated be droplets 656 into the liquid collection section of housing 612 indicated as 660. Container 614 also has a wall 664 that extends upwardly from outlet 642 and terminates at generally circular opening 668 at the top thereof. Reservoir has a generally circular lower opening or outlet 672 that is sized is large enough to permit liquid to flow out as indicated by droplet 676 onto solids 650. Reservoir 618 also has a wall 680 that extends upwardly from outlet 672, and terminates at generally circular opening 684 at the top thereof proximate upper edge 630 of housing 612. As shown in FIG. 8, vents 634 are positioned vertically on wall 626 of housing 612 between the lower outlet 672 of reservoir 618 and the upper opening 668 of container 614.

In operation, lower container 614 is filled or loaded with solids 650 and then upper reservoir 618 is filled with the liquid activator, such as water, or vice versa. The liquid activator drips through opening 672 onto one or more solids 650 over which it is positioned, thus releasing the fragrance contained therein as solids 650 are dissolved, the fragrance then passing outwardly through vents 634. If solids 650 also contain a water-activated effervescent component, contact with the water in lower container 614 will cause desirable effervescence to occur as well. Over time, one or more of solids 650 are progressively dissolved by the liquid activator descending from opening 672, and eventually decrease in size and lose their integrity, causing other adjacent solids to shift and advance into their place due to gravity, thus continuing the process of incremental fragrance release, as well as desirable effervescence generation. At the same time, the liquid activator that descends into lower container 614 is drained off via opening 642, as indicated by drops 656, into liquid collection section 660. This process continues until the last solid 650 has been completely or almost completely dissolved, or until the liquid activator in upper reservoir 618 is completely dispensed into lower container 614 and finally into liquid collection section 660.

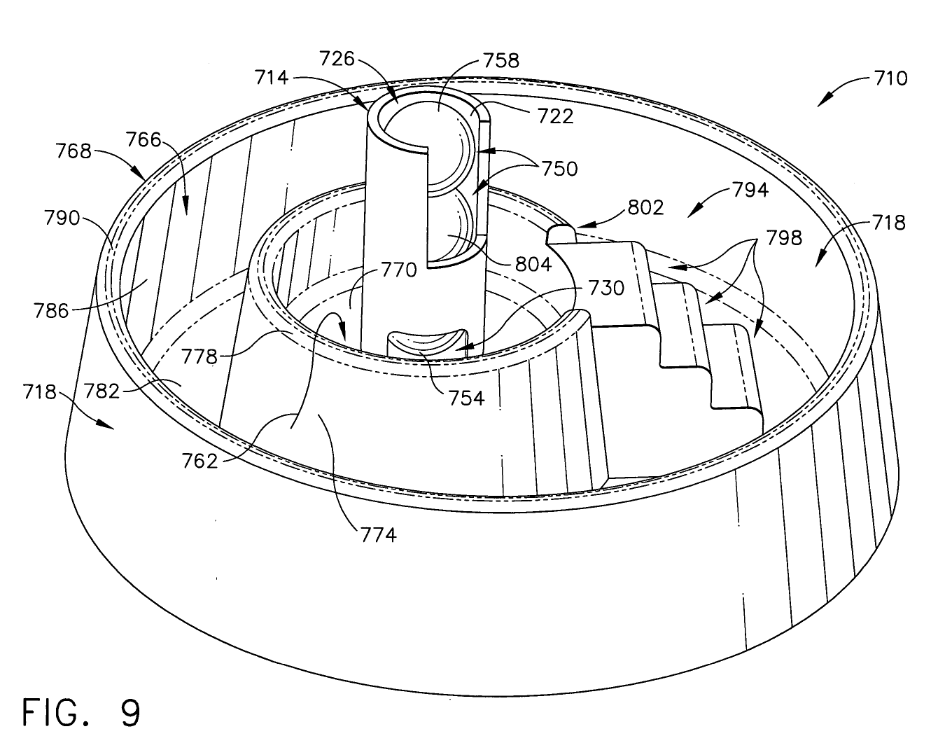

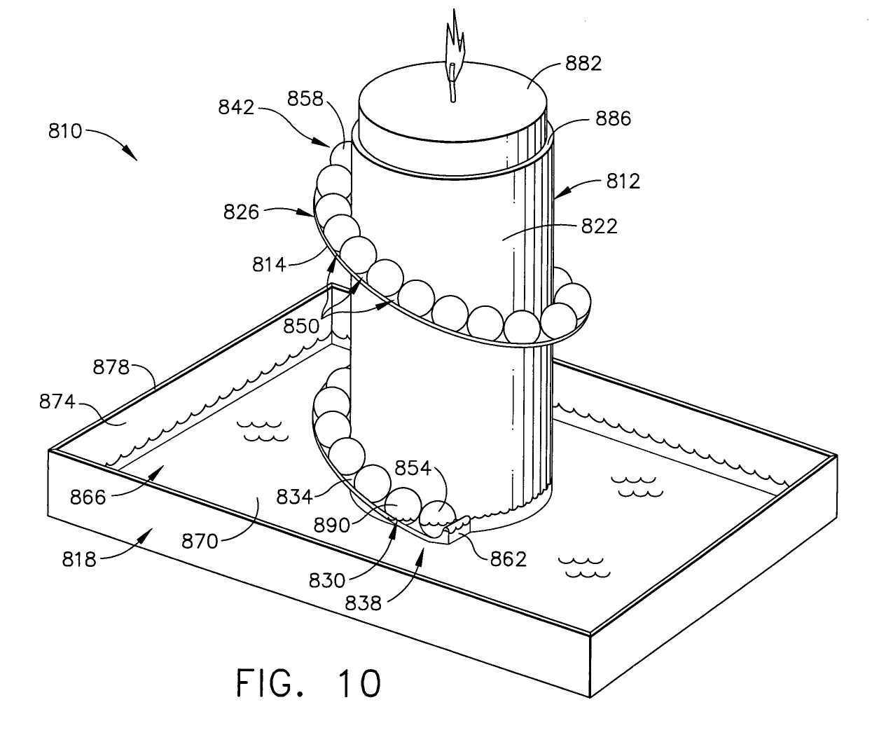

FIG. 9 shows an alternative embodiment of this dispensing system indicated generally as 710. System 710 has a dispenser in the form of a generally cylindrical shaped vertical guide chamber indicated as 714, and a bowl-shaped liquid activator reservoir indicated generally as 718 in which chamber 714 is positioned. Chamber 714 has an inner generally cylindrical surface 722, an upper opening or entrance indicated as 726 at the top thereof and an lower opening or exit at the bottom thereof indicated as 730. As shown in FIG. 9, a plurality of generally spherical fragrance containing solids 750 are vertically and sequentially loaded within chamber 714. As also shown in FIG. 9, these solids 750 are sized to be smaller than inner surface 722, but larger than exit 730 so that these solids can be sequentially dispensed from chamber 714 due to gravity. The first or lower most solid indicated as 754 is shown as being proximate exit 730 while the last or upper most solid indicated as 758 is proximate entrance 726.

As shown in FIG. 9, reservoir 718 has an inner section indicated generally as 762, and an outer section indicated generally as 766. Inner section 762 has a base or bottom 770 from which inner wall 774 of section 762 extends vertically upwardly and terminates at upper edge 778. Outer section 766 has a base or bottom 782 from which outer wall 786 extends vertically upwardly and terminates at upper edge 790. As shown in FIG. 9, edge 790 of outer wall 786 is vertically above edge 778 of inner wall 774, i.e., outer wall 786 is higher than that of inner wall 774. For aesthetic and functional benefits, dispensing system 710 can also be provided with a stairway or ramp indicated as 794 having a plurality of discrete steps indicated as 798 (these steps 798 can be replaced by a continuous slope) that extend downwardly from gap 802 formed in upper edge 778 of inner wall 774, to base 782 of outer section 768.

In operation, chamber 714 is filled or loaded with solids 750 and then inner section 762 is filled with the liquid activator, such as water, or vice versa, such that first solid 754 is at least partially immersed in the water, thus releasing the fragrance contained therein as solid 754 is dissolved. If solid 754 also contains a water-activated effervescent component, contact with the water in inner section 762 will cause desirable effervescence to occur as well. When liquid activator is added to inner section 762, any excess will spill over gap 802 and down stairway or ramp 794 into outer section 782 of reservoir 718. Over time, solid 754 is progressively dissolved by the water in inner section 762 and eventually decreases in size and loses its integrity. As solid 754 decreases in size/loses integrity, the next adjacent solid 804 advances down chamber 714 due to gravity, and eventually comes into contact with the water in inner section 762 when solid 754 has partially or completely dissolved, thus continuing the process of incremental fragrance release, as well as desirable effervescence generation. This process continues until the last solid 758 has been completely or almost completely dissolved, or until the water in inner section 762 approaches the solubility limit or pH limit of the dissolved solids 750 in the liquid activator such that fragrance release and effervescent action occurs very slowly or not at all. Additional liquid activator can also be added to dilute the liquid activator in inner section 762, thereby causing the excess liquid activator containing undissolved carbonate salts and residual fragrance to spill down stairway or ramp 794 that provides greater surface area and agitation to encourage any residual fragrance contained in the liquid activator to be desirably released into the air, and then into outer section 782 of reservoir 718.

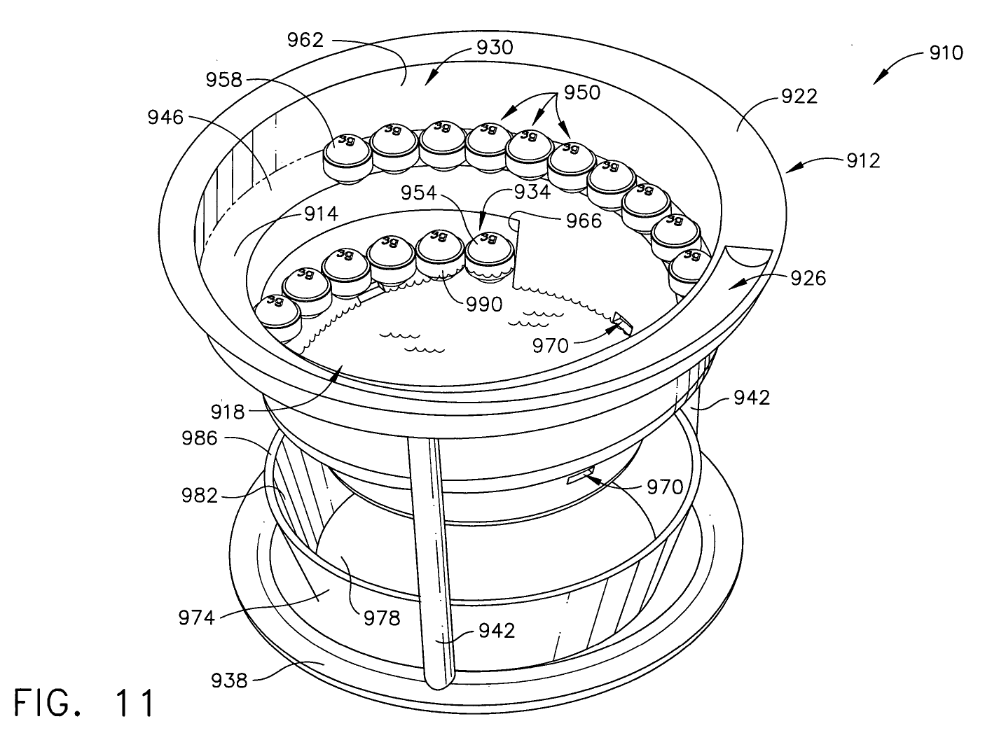

FIG. 10 shows an alternative embodiment of this dispensing system indicated generally as 810. System 810 has a generally cylindrical housing indicated as 812, a dispenser in the form a helical ramp indicated as 814 and a generally tray-shaped liquid activator reservoir indicated as 818 in which housing 812 is positioned. As shown in FIG. 10, ramp 814 spirals along the exterior surface 822 of housing 812 from its upper or entrance section indicated as 826 downwardly to its lower or exit section indicated as 830.

As shown in FIG. 10, a plurality of generally spherical fragrance-containing solids 850 are sequentially loaded onto surface 834 of ramp 814. The first or lower most solid indicated as 854 is shown as being proximate the lower end 838 of exit section 830, while the last or upper most solid indicated as 858 is shown as being proximate the upper end 842 of entrance section 826. Solid 854 is held in place against further movement down ramp 814 by stop indicated as 862 that extends vertically from lower end 838 of exit section 830. Reservoir 818 has an inner surface indicated generally as 866 that has a base or bottom indicated as 870, and a wall 874 that extends vertically and upwardly from base 870 and terminates at upper edge 878. For aesthetic and functional benefits, dispensing system 810 can also be provided with a candle indicated as 882 that fits within the generally circular opening indicated as 886 at the upper end of housing 812.

In operation, solids 850 are loaded onto surface 834 of ramp 814 and then liquid activator such as water is added to reservoir 818, or vice versa, such that first solid 854 is at least partially immersed in the water. Candle 882 is then ignited and, if it is fragrance-containing, begins to incrementally release fragrance, preferably identical to or compatible with the fragrance contained in solids 850. The first solid 854 which rests against stop 862 comes into contact with the water in reservoir 818, thus releasing the fragrance contained therein as solid 854 is dissolved. If solid 854 also contains a water-activated effervescent component, contact with the water in reservoir 818 will also cause desirable effervescence to occur as well. Over time, solid 854 is progressively dissolved by the water in reservoir 818, and eventually decreases in size and loses its integrity. As solid 854 decreases in size/loses integrity, the next adjacent solid 890 advances down inclined surface 834 due to gravity, and eventually comes into contact with the water in reservoir 818 when solid 854 has partially or completely dissolved, thus continuing the process of incremental fragrance release, as well as desirable effervescence generation. Like solid 854, the movement of solid 890 down inclined surface 834 is arrested by stop 862. This process continues until the last solid 858 has been completely or almost completely dissolved, or until the water in reservoir 818 approaches the solubility or pH limit of the dissolved solids 850 in the liquid activator such that fragrance release and effervescent action occurs very slowly or not at all from solids 850. Fragrance release can continue from candle 882 for as long as the fragrance-containing portion remains present and unburned.

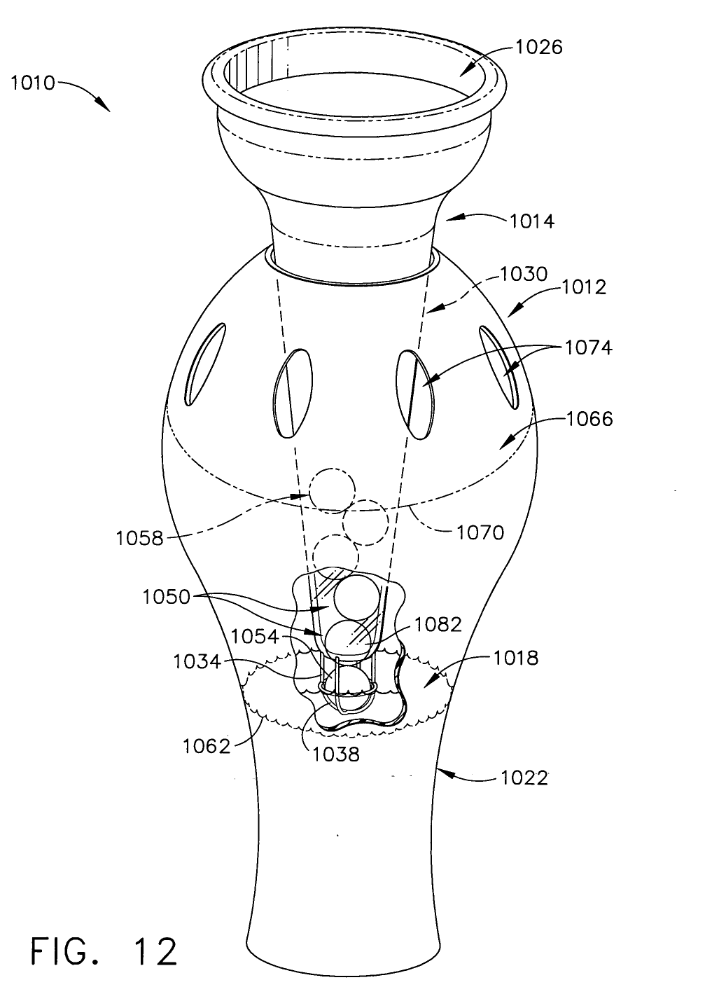

FIG. 11 shows an alternative embodiment of the dispensing system of FIG. 10 and is indicated generally as 910. System 910 has a generally bowl-shaped housing indicated as 912 that includes a dispenser in the form a helical ramp indicated as 914 and a liquid activator reservoir indicated as 918. As shown in FIG. 11, ramp 914 begins at the upper annular surface 922 of housing 912 at an upper or entrance section 926, and then spirals along the interior surface 930 of housing 912 downwardly to a lower or exit section indicated as 934. Housing 912 is also shown as being supported on a base 938 by a plurality of spaced apart legs or support members indicated as 942.

As shown in FIG. 11, a plurality of generally spherical fragrance-containing solids 950 are sequentially loaded onto surface 946 of ramp 914. The first or lower most solid indicated as 954 is shown as being proximate the lower end of exit section 934, while the last or upper most solid indicated as 958 is shown as being positioned on an upper section indicated as 962 of the ramp 914. Solid 954 is held in place against further movement down ramp 914 by a stop in the form of a vertical wall or shoulder indicated as 966 formed in housing 912. As shown in FIG. 11, reservoir 918 is provided with a plurality of overflow ports 970 that are formed in housing 912 and spaced along the circumference thereof to allow the flow of liquid from reservoir 918 into a generally bowl shaped collection trough 974 positioned under reservoir 918 and on base 938, and having a base or bottom 978, and a wall 982 extending upwardly from base 978 and terminating at an upper edge 986.

In operation, solids 950 are loaded onto surface 946 of ramp 914 and then liquid activator such as water is added to reservoir 918, or vice versa, such that first solid 954 is at least partially immersed in the water. To the extent that the volume of liquid activator rises above the level of overflow ports 970, any excess would cascade out ports 970 and into trough 974. The first solid 954 which rests against stop 966 comes into contact with the water in reservoir 918, thus releasing the fragrance contained therein as solid 954 is dissolved. If solid 954 also contains a water-activated effervescent component, contact with the water in reservoir 918 will also cause desirable effervescence to occur as well. Over time, solid 954 is progressively dissolved by the water in reservoir 918 and eventually decreases in size and loses its integrity. As solid 954 decreases in size/loses integrity, the next adjacent solid 990 advances down inclined surface 946 due to gravity, and eventually comes into contact with the water in reservoir 918 when solid 954 has partially or completely dissolved, thus continuing the process of incremental fragrance release, as well as desirable effervescence generation. This process continues until the last solid 958 has been completely or almost completely dissolved, or until the water in reservoir 918 approaches the solubility or pH limit of the dissolved solids 950 in the liquid activator such that fragrance release and effervescent action occurs very slowly or not at all. Additional liquid activator can also be added to reservoir 918, thus diluting the concentration of dissolved solids 950, in which case the effervescent action and fragrance release can resume or accelerate, with any liquid activator exceeding the volume capacity of reservoir 918 overflowing through ports 970 and spilling into trough 974 to be retained therein.

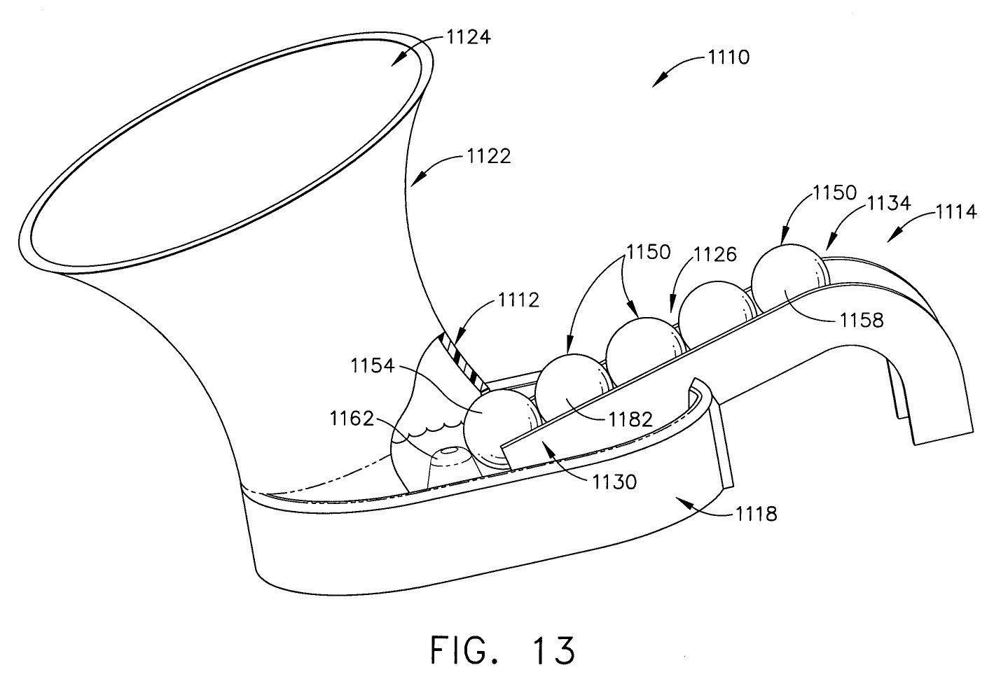

Another embodiment of this dispensing system is shown in FIG. 12 and is indicated as 1010. System 1010 comprises a generally vase-shaped housing 1012, a generally vial or funnel-shaped dispenser indicated as 1014 and a liquid activator reservoir indicated as 1018 that is located in the lower section 1022 of housing 1012. Dispenser 1014 has a generally circular opening or entrance 1026 at the top thereof that is connected to a generally cone-shaped neck 1030 that terminates at the lower end thereof in a generally circular opening or exit indicated as 1034 that is positioned over reservoir 1018. As shown in FIG. 12, a wire mesh collection basket indicated as 1038 is positioned under exit 1034, and is at least partially submerged in the liquid activator in reservoir 1018.

As shown in FIG. 12, a plurality of generally spherical fragrance-containing solids indicated as 1050 are collected within neck 1030 of dispenser 1014. Solids 1050 have a diameter that is sized to be smaller than exit opening 1034 so as to allow the solids to enter basket 1038. The first or lower most solid 1054 is held within basket 1038 so that is partially submerged below the level 1062 of reservoir 1018.

Housing 1012 also has an upper section indicated as 1066 that can be detached along edge 1070 from lower section 1022. Upper section 1066 is also shown as being provided with a plurality of vents in the form of oval apertures 1074 spaced along the circumference thereof.

In operation, solids 1050 are loaded into opening 1026 with the first or lowermost solid 1054 dropping into basket 1038, accumulating within neck 1030, and then liquid activator such as water is added to reservoir 1018, or vice versa, such that first solid 1054 is at least partially immersed in the water within basket 1038. The first solid 1054 which is held within basket 1038 comes into contact with the water in reservoir 1018, thus releasing the fragrance contained therein as solid 1054 is dissolved. The fragrance release is enhanced and made more readily noticeable by being able to rise and escape through vents 1074 in housing 1012. If solid 1054 also contains a water-activated effervescent component, contact with the water in reservoir 1018 will also cause desirable effervescence to occur as well. Over time, solid 1054 is progressively dissolved by the water in reservoir 1018 and eventually decreases in size and loses its integrity. As solid 1054 decreases in size/loses integrity, the next adjacent solid 1082 advances down neck 1030 due to gravity, and eventually comes into contact with the water in reservoir 1018 when solid 1054 has partially or completely dissolved, thus continuing the process of incremental fragrance release, as well as desirable effervescence generation. This process continues until the last solid 1058 has been completely or almost completely dissolved, or until the water in reservoir 1018 approaches the solubility or pH limit of the dissolved solids 1050 in the liquid activator such that fragrance release and effervescent action occurs very slowly or not at all.

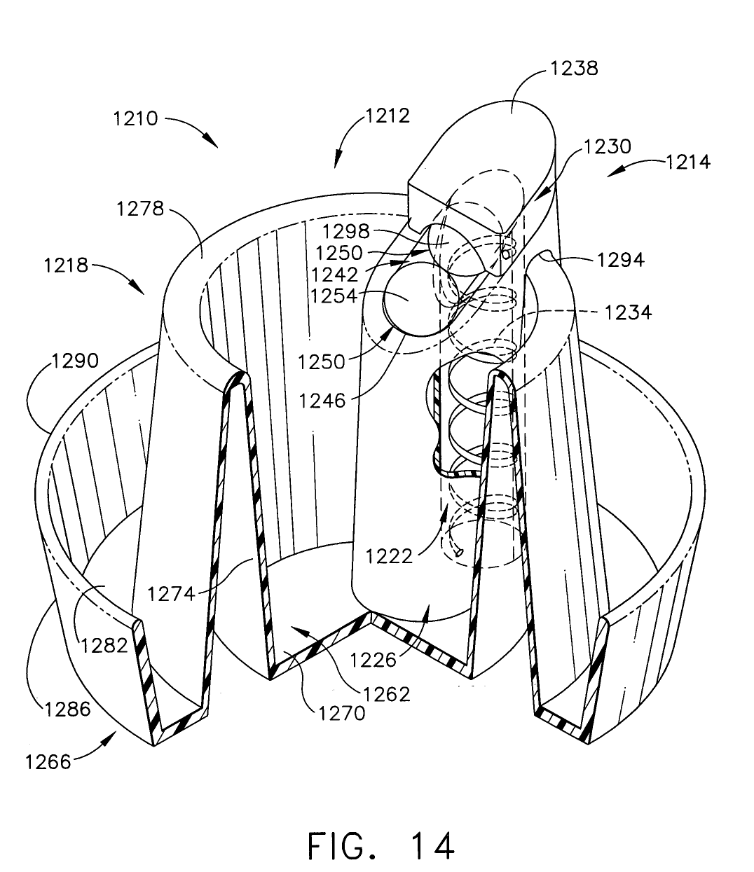

Another embodiment of this dispensing system for providing an auditory effect when an effervescent component is used is shown in FIG. 13 and is indicated as 1110. System 1110 comprises a generally horn-shaped housing 1112 having a generally J-shaped dispenser portion 1114, a generally bowl-shaped liquid activator reservoir portion indicated as 1118 and an auditory generally bell-shaped portion indicated as 1122 having a generally circular opening indicated as 1124. Ramp portion 1114 has an inclined section indicated as 1126 that has a lower or exit end indicated as 1130, and an upper or entrance end indicated as 1134.

As shown in FIG. 13, a plurality of generally spherical fragrance-containing solids 1150 are sequentially loaded in inclined section 1126. The first or lower most solid indicated as 1154 is shown as being proximate exit end 1130, while the last or upper most solid indicated as 1158 is shown as being proximate entrance end 1134. Solid 1154 is held in place against further movement down inclined section 1126 by a conical-shaped stop indicated as 1162 that is releasably or permanently attached to or integral with reservoir portion 1118.

In operation, solids 1150 are loaded into entrance 1134 of dispenser 1114 and then liquid activator such as water is added to reservoir 1118, or vice versa, such that first solid 1154 is at least partially immersed in the water. The first solid 1154 which rests against stop 1162 comes into contact with the water in reservoir 1118, thus releasing the fragrance contained therein as solid 1154 is dissolved. If solid 1154 also contains a water-activated effervescent component, contact with the water in reservoir 1118 will also cause desirable effervescence to occur as well, which will provide a desirable auditory benefit that is amplified by bell 1122. Over time, solid 1154 is progressively dissolved by the water in reservoir 1118 and eventually decreases in size and loses its integrity. As solid 1154 decreases in size/loses integrity, the next adjacent solid 1182 advances down inclined section 1126 due to gravity, and eventually comes into contact with the water in reservoir 1118 when solid 1154 has partially or completely dissolved, thus continuing the process of incremental fragrance release, as well as desirable effervescence generation. This process continues until the last solid 1158 has been completely or almost completely dissolved, or until the water in reservoir 1118 approaches the solubility or pH limit of the dissolved solids 1150 in the liquid activator such that fragrance release and effervescent action occurs very slowly or not at all.

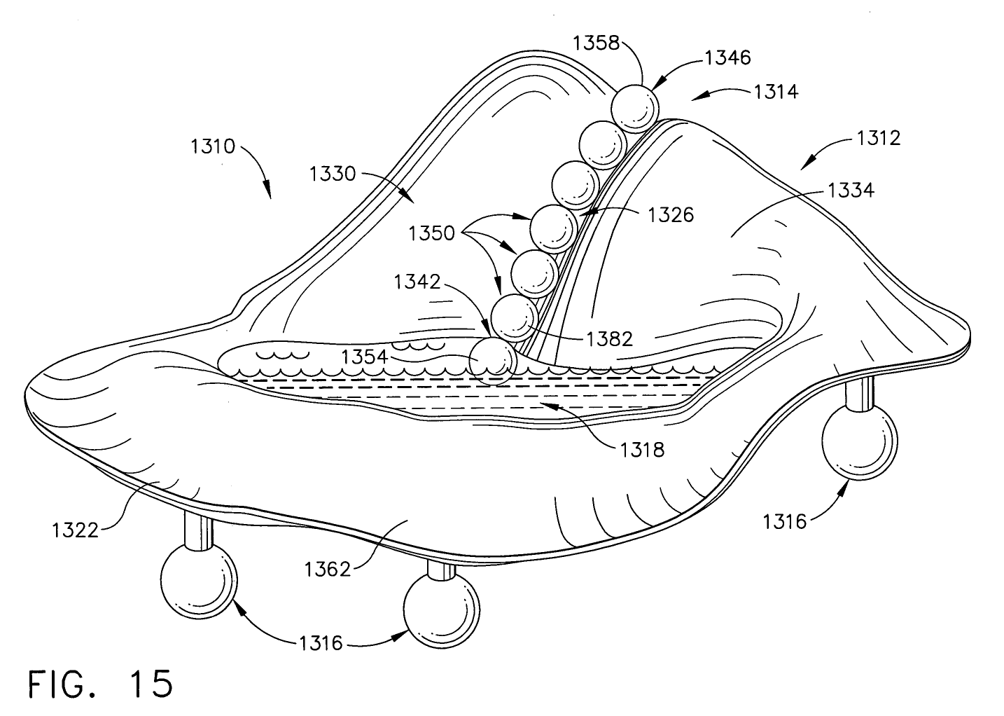

Another embodiment of this dispensing system that uses mechanical assistance in dispensing the fragrance-containing solids is shown in FIG. 14 and is indicated as 1210. System 1210 has a housing indicated generally as 1212 that includes a dispensing section indicated generally as 1214 and a liquid activator reservoir section indicated generally as 1218. Dispensing section 1214 has a generally cylindrical supply chamber or well 1222 that extends generally vertically upwardly from proximate the base 1226 of dispensing section 1214 to proximate the top outlet 1230 thereof. As shown in FIG. 14, a mechanism in the form of a spring 1234 is provided for urging upwardly a plurality of generally spherical fragrance-containing solids 1250 that are sequentially loaded into supply well 1222. These solids 1250 are restrained from further upward movement by a stop in the form of cap 1238 that is positioned over the top 1230 of well 1222. As shown in FIG. 14, the first solid in the sequence of solids indicated as 1254, after reaching the top 1230 of well 1222, moves downwardly due to gravity along a track indicated as 1242 until solid 1254 reaches the lower end of track 1242 as indicated by 1246 where solid 1254 is then secured against further movement.

As shown in FIG. 14, reservoir section 1218 includes an inner section indicated as 1262 and an outer section indicated as 1266. Inner section 1262 has a base or bottom 1270 and a wall 1274 that extends generally upwardly from base 1270 and terminates at upper edge 1278. Outer section 1266 also has a base or bottom 1282 and a wall 1286 that extends generally upwardly from base 1282 and terminates at upper edge 1290. As shown in FIG. 14, the upper edge 1278 of wall 1274 is above that of the upper edged 1290 of wall 1286, i.e., wall 1274 is higher than wall 1286. As also shown in FIG. 14, edge 1278 of wall 1274 is above the lower end 1246 of track 1242 so that solid 1254 is at least partially submerged in the liquid activator present in inner section 1262 of reservoir 1218. As also shown in FIG. 14, dispensing section 1214 can be releasably secured to the reservoir section 1218 by forming a slot therein indicated as 1294 that is configured to fit over wall 1274 and thus permit the lower end 1246 of track 1242 to be positioned within inner section 1262 of reservoir 1218.

In operation, solids 1250 are sequentially loaded into chamber 1222 and then cap 1238 is pushed down, encouraging the solids to proceed down track 1242 to its lower end 1246, and then liquid activator such as water is added to inner reservoir 1262, or vice versa, such that first solid 1254 is at least partially immersed in the water. To the extent that the volume of water rises above upper edge 1278, any excess cascades into outer reservoir 1266. The first solid 1254 which rests against lower end 1246of track 1242 comes into contact with the water in inner reservoir 1262, thus releasing the fragrance contained therein as solid 1254 is dissolved. If solid 1254 also contains a water-activated effervescent component, contact with the water in inner reservoir 1262 will also cause desirable effervescence to occur as well. Over time, solid 1254 is progressively dissolved by the water in inner reservoir 1262 and eventually decreases in size and loses its integrity. As solid 1254 decreases in size/loses integrity, the next adjacent solid 1298 advances down track 1242 due to mechanical assistance or action of spring 1234, and eventually comes into contact with the water in inner reservoir 1262 when solid 1254 has partially or completely dissolved, thus continuing the process of incremental fragrance release, as well as desirable effervescence generation. This process continues until the last solid 1298 has been completely or almost completely dissolved, or until the water in inner reservoir 1262 approaches the solubility or pH limit of the dissolved solids 1250 in the liquid activator such that fragrance release and effervescent action occurs very slowly or not at all. Additional liquid activator can also be added to inner section 1262, thus diluting the concentration of dissolved solids 1250, in which case the effervescent action and fragrance release will resume or accelerate, with any liquid activator exceeding the capacity of inner section 1262 overflowing above edge 1278 and spilling into outer section 1266 to be retained therein.

Another embodiment of this dispensing system in the form of an aesthetically pleasing landscape scene is shown in FIG. 15 and is indicated as 1310. System 1310 comprises a housing 1312 having a dispensing section indicated generally as 1314, a reservoir section indicated generally as 1318. Housing 1312 is shown as being supported by a plurality of spaced legs or support members indicated as 1316 that extend generally downwardly from the base 1322 of housing 1312. Dispensing section 1314 has a downwardly sloping inclined groove or track 1326 that is formed by two adjacent upwardly extending mountainous or hill-shaped protrusions 1330 and 1334 formed in housing 1312.

As shown in FIG. 15, a plurality of generally spherical fragrance-containing solids 1350 are sequentially loaded onto track 1326. The first or lower most solid indicated as 1354 is shown as being proximate lower exit 1342 of track 1326, while the last or upper most solid indicated as 1358 is shown as being proximate upper entrance 1346 of track 1326. Although not shown, solid 1354 held in place against further movement down track 1322 by a stop, for example a protrusion simulating a rock that protrudes upwardly from reservoir 1318. Reservoir section 1318 defined by an upwardly protruding shoulder indicated as 1362 that is formed in base 1322 of housing 1312 that simulates a gentle hill or slope.

In operation, groove 1326 of dispensing section 1314 is filled or loaded with solids 1350 and then reservoir 1318 is filled with the liquid activator, such as water, or vice versa, such that first solid 1354 is at least partially immersed in the water. The first solid 1354 which rests against a stop (not shown) comes into contact with the water in reservoir 1318, thus releasing the fragrance contained therein as solid 1354 is dissolved. If solid 1354 also contains a water-activated effervescent component, contact with the water in reservoir 1318 will also cause desirable effervescence to occur as well. Over time, solid 1354 is progressively dissolved by the water in reservoir 1318 and eventually decreases in size and loses its integrity. As solid 1354 decreases in size/loses integrity, the next adjacent solid 1382 advances down groove 1326 due to gravity, and eventually comes into contact with the water in reservoir 1318 when solid 1354 has partially or completely dissolved, thus continuing the process of incremental fragrance release, as well as desirable effervescence generation. Like solid 1354, the movement of solid 1382 down groove 1326 is arrested by the stop (not shown). This process continues until the last solid 1358 has been completely or almost completely dissolved, or until the water in reservoir 1318 approaches the solubility or pH limit of the dissolved solids 1350 in the liquid activator such that fragrance release and effervescent action occurs very slowly or not at all.

While specific embodiments of the present invention have been described, it will be apparent to those skilled in the art that various modifications thereto can be made without departing from the spirit and scope of the present invention as defined in the appended claims.

1. A dispensing system for providing a sustained release of fragrance over time by bringing incrementally into contact by gravity assistance, mechanical assistance or combination thereof, a liquid activator and an incremental, discrete portion of a solid that, when combined, release a fragrance so as to cause a sustained, incremental release thereof over time.

2. The system of claim 1 wherein discrete units of a fragrance-containing solid are brought into sequential contact with the liquid activator so as to incrementally release the fragrance from the fragrance-containing solid.

3. The system of claim 1 wherein the liquid activator is brought into contact with discrete, sequential units of a fragrance-containing solid so as to incrementally release the fragrance from the fragrance-containing solid.

4. The system of claim 1 which comprises a plurality of fragrance-containing solids that are sequentially brought in contact with the liquid activator.

5. The system of claim 4 which comprises a dispenser loaded with the solids and a reservoir containing the liquid activator, the dispenser being positioned proximate the reservoir to permit sequential contact of the solids with the liquid activator.

6. The system of claim 5 wherein the dispenser has a downwardly inclined ramp on which the solids are loaded so as to provide a first solid and a last solid, and a reservoir containing the liquid activator, the ramp having a upper entrance and a lower exit, the first solid being proximate the lower exit, the lower exit being positioned proximate to the reservoir so that the first solid is at least partially immersed in the liquid activator.

7. The system of claim 6 which further comprises a housing having an outer surface, and wherein the ramp has a helical configuration so that the ramp spirals downwardly along the outer surface of the housing.

8. The system of claim 6 which further comprises a housing having an inner surface, and wherein the ramp has a helical configuration so that the ramp spirals downwardly along the inner surface of the housing.

9. The system of claim 6 wherein the plurality of solids have a generally spherical shape and are sequentially loaded onto the ramp.

10. The system of claim 5 which comprises a dispenser having a generally vertical guide chamber within which the solids are loaded so as to provide a first solid and a last solid, the guide chamber having a upper entrance and a lower exit, the first solid being proximate the lower exit, the lower exit being positioned proximate the reservoir so that the first solid is at least partially immersed in the liquid activator.

11. The system of claim 5 wherein the dispenser comprises an elongated vertical post and wherein each of the solids have a hole formed for loading the solids onto the post.

12. The system of claim 4 wherein there the reservoir comprises a first section and a second section, the fragrance containing solids being brought into contact with the liquid activator in the first section, the second section being in liquid communication with the first section and being able to: (a) remove liquid activator from the first section; (b) add liquid activator to the first section; or (c) a combination thereof.

13. The system of claim 12 wherein the first section is an inner section of the reservoir and wherein the second section is an outer section of the reservoir.

14. The system of claim 4 wherein a valve is provided to control the amount of liquid activator present in the reservoir.

15. The system of claim 1 wherein portions of the liquid activator are incrementally brought into contact with a fragrance-containing solid.

16. The system of claim 15 which comprises a reservoir containing the liquid activator and at least one outlet for incrementally dispensing the liquid activator therefrom, and a container having at least one fragrance containing solid, the container being positioned relative to the reservoir so that liquid activator dispensed from reservoir is brought into contact with the at least one fragrance containing solid.

17. The system of claim 16 wherein the container has at least one outlet for dispensing liquid activator received from the reservoir and which further comprises a collector, the collector being positioned relative to the container so that liquid activator dispensed from the container is received thereby.

18. The system of claim 1 wherein the solid further comprises an effervescent component that generates effervescence when contacted by the liquid activator.

19. The system of claim 18 which further comprises an auditory component for enhancing the auditory effect of the generated effervescence.

20. The system of claim 19 wherein the auditory component is configured to have the shape of the bell of a musical instrument.

21. The system of claim 1 wherein the liquid activator contains at least a portion of the fragrance.

22. The system of claim 1 which further comprises a scent-containing candle.

23. A dispenser for providing a sustained release of fragrance over time that utilizes gravity assistance, mechanical assistance or combination thereof to bring a liquid activator and an incremental, discrete portion of a solid into incremental contact, the liquid activator and solid, when combined, release a fragrance so as to cause a sustained, incremental release thereof over time.

24. The dispenser of claim 23 wherein discrete units of a fragrance-containing solid are brought into sequential contact with the liquid activator so as to incrementally release the fragrance from the fragrance-containing solid.

25. The dispenser of claim 23 wherein the liquid activator is brought into contact with discrete, sequential units of a fragrance-containing solid so as to incrementally release the fragrance from the fragrance-containing solid.

26. A method for providing a sustained release of fragrance over time which comprises the step of: (a) bringing into incremental contact by gravity assistance, mechanical assistance or combination thereof, a liquid activator and an incremental, discrete portion of a solid that, when combined, release a fragrance so as to cause a sustained, incremental release thereof over time.

27. The method of claim 26 which comprises the step of bringing discrete units of a fragrance-containing solid into sequential contact with the liquid activator so as to incrementally release the fragrance from the fragrance-containing solid.

28. The method of claim 26 which comprises the step of bringing the liquid activator into contact with discrete, sequential units of a fragrance-containing solid so as to incrementally release the fragrance from the fragrance-containing solid.

29. The method of claim 26 wherein the liquid activator is water.

30. The method of claim 29 wherein an effervescent action is generated when the solid and water are combined.

31. The method of claim 29 wherein single or multiple-colored effects are generated when the solid and water are combined.
